(19) United States
(12) Patent Application Publication
(10) Pub. No.: US 2010/0003485 A1
(43) Pub. Date: Jan. 7, 2010

(54) NONWOVEN WEB COMPRISING POLYARENAZOLE MICROFIBERS AND PROCESS FOR MAKING SAME

(75) Inventors: Joseph Brian Hovanec, Richmond, VA (US); W. Douglas Bates, III, Chester, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY

(21) Appl. No.: 12/375,534

(22) PCT Filed: Jul. 26, 2007
(86) PCT No.: PCT/US2007/074461

§ 371 Date: Jan. 29, 2009

Related U.S. Application Data
(60) Provisional application No. 60/834,425, filed on Jul. 31, 2006.

(51) Int. Cl. B32B 33/00; D03D 9/00; B29C 47/00

(52) U.S. Cl. 428/219; 442/1; 264/466

(57) ABSTRACT

Provided is a fiber web comprising polymer fiber having an average fiber diameter of about 20 to 5000 nm, where the polymer fiber comprises a polyarenazole polymer having an inherent viscosity of greater than about 20 g/dl and the fiber web has a basis weight of from about 0.1 to 200 grams per square meter. Also provided are articles comprising such webs and methods of preparing such webs.

### FIELD OF THE INVENTION

The present invention concerns nonwoven webs comprising polyarenazole microfibers and processes for making such webs.

### BACKGROUND OF THE INVENTION

The present invention concerns polyarenazole microfilaments and processes for making such filaments.

### BACKGROUND OF THE INVENTION

Certain low denier fibers have been shown to be useful in a variety of end uses such as filtration media, cell & tissue cultures, drug delivery systems, and specialty textiles.

U.S. Pat. No. 4,263,245 describes certain low denier, high-strength polybibenzimidazole filaments that are 20 to 200 microns in diameter.

Filtration mediums, fine particle wipe mediums and absorbent mediums containing a mixture of submicron and greater than submicron fibers are disclosed in U.S. Pat. No. 6,315,806. Preferred fibers are said to be made from polypropylene polymer. Published U.S. Application No. 20050026526 discloses filter media having a mixture of course fibers and fine fibers of diameter less than 1 μm.

PCT Patent Application No. WO 03/080905 discloses the preparation of a nanofiber web by an electro-blown spinning process. PCT Patent Application No. WO 05/026398 describes production of nanofibers by reactive electrospinning.

A method for producing a webbed fibrillar material is disclosed in published U.S. Application No. 20050048274. The process injects polymer through an electric field towards an electrically charged target.

As is shown in the prior art the strength and durability of the resulting nanofiber web results in the need to use a supporting scrim of larger diameter fibers for added strength and reinforcement. It is the intention of this invention to put forth a method of producing nanofibers of high strength polymers to improve the strength and durability of the resulting nanofiber web.

### SUMMARY OF THE INVENTION

In some embodiments, provided is a fiber web comprising polymer fiber having an average fiber diameter of about 20 to 5000 nm, where the polymer fiber comprises a polyarenazole polymer having an inherent viscosity of greater than about 20 g/dl and the fiber web has a basis weight of from about 0.1 to 200 grams per square meter.

Some webs a basis weight is in the range of about 0.1 to 100 grams per square meter. Other webs have a basis weight in the range of about 0.3 to 80 grams per square meter.

Some polyarenazole polymers have an inherent viscosity of greater than about 25 g/dl. Other polyarenazole polymer have an inherent viscosity of greater than about 28 g/dl. One useful polyarenazole polymer fiber is a polypyridazole polymer fiber. A particularly useful polypyridazole polymer fiber is a poly[2,6-d]imidazo[4,5-b:4,5-e]-pyridinylene-1,4-(2,5-dihydroxy)phenylene) polymer fiber.

In some embodiments, fiber web additionally includes a scrim.

The invention also relates to articles comprising a fiber web described herein.

In another aspect, the invention concerns a method of producing a web of polyarenazole fibers comprising:
extruding a solution comprising polyarenazole polymer through a spinneret having a first applied voltage; and
collecting the extruded polyarenazole polymer on a collection surface optionally having a second applied voltage that is opposite in polarity to the first applied voltage.

In some embodiments, the polyarenazole polymer comprises polyphosphoric acid as a solvent. In some methods, the first applied voltage is in the range of 1 kV to 300 kV. In certain methods, the second applied voltage is in the range of 0 to −10 kV. In some methods the polarity of the applied voltages may be reversed, such that the first applied voltage is in the range of −1 kV to −300 kV and the second applied voltage is in the range of 0 to +10 kV.

In some embodiments, the method additionally comprises the step of passing the extruded polyarenazole polymer solution through an air gap. The extruded polymer can be accelerated in the air gap by providing air flow along the direction between the spinneret and collection surface In certain embodiments, the second applied voltage is zero.

### DETAILED DESCRIPTION OF ILLUSTRATIVE EMBODIMENTS

In some embodiments, provided is a fiber web comprising polymer fiber having an average fiber diameter of about 20 to 5000 nm, where the polymer fiber comprises a polyarenazole polymer having an inherent viscosity of greater than about 20 g/dl and the fiber web has a basis weight of from about 0.1 to 200 grams per square meter. The invention also relates to articles comprising such webs and to methods of preparing such webs.

The nonwoven webs of the instant invention utilize polyarenazole microfibers. Polyareneazole polymer may be made by reacting a mix of dry ingredients with a polyphosphoric acid (PPA) solution. The dry ingredients may comprise azole-forming monomers and metal powders. Accurately weighed batches of these dry ingredients can be obtained through employment of at least some of the preferred embodiments of the present invention.

Exemplary azole-forming monomers include 2,5-dimercapto-p-phenylene diamine, terephthalic acid, bis-(4-benzoic acid), oxy-bis-(4-benzoic acid), 2,5-dihydroxyterephthalic acid, isophthalic acid, 2,5-pyridodicarboxylic acid, 2,6-napthalenedicarboxylic acid, 2,6-quinolinedicarboxylic acid, 2,6-bis(4-carboxyphenyl) pyridobisimidazole, 2,3,5,6-tetraminopyridine, 4,6-diaminoresorcinol, 2,5-diaminohydroquinone, 1,4-diamino-2,5-dithiobenzene, or any combination thereof. Preferably, the azole forming monomers include 2,3,5,6-tetraminopyridine and 2,5-dihydroxyterephthalic acid. In certain embodiments, it is preferred that that the azole-forming monomers are phosphorylated. Preferably, phosphorylated azole-forming monomers are polymerized in the presence of polyphosphoric acid and a metal catalyst.

Metal powders can be employed to help build the molecular weight of the final polymer. The metal powders typically include iron powder, tin powder, vanadium powder, chromium powder, and any combination thereof.

The azole-forming monomers and metal powders are mixed and then the mixture is reacted with polyphosphoric acid to form a polyareneazole polymer solution. Additional polyphosphoric acid can be added to the polymer solution if desired.

Polybenzoxazole (PBO) and polybenzothiazole (PBZ) two suitable polymers. These polymers are described in PCT Application No. WO 93/20400. Polybenzoxazole and polybenzothiazole are preferably made up of repetitive units of the following structures:

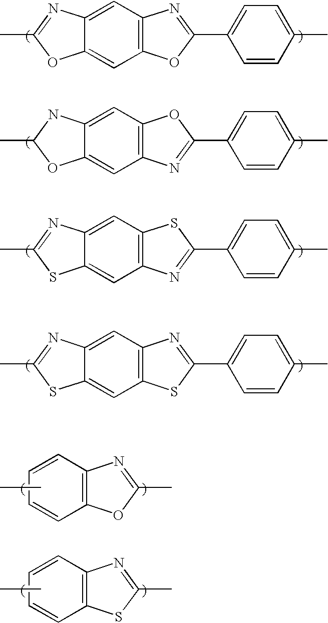

Polybibenzimidazole polymer is described in U.S. Pat. No. 2,895,948 and U.S. Reissue 26,065 and can be made by known processes such as those disclosed in U.S. Pat. No. 3,441,640 and U.S. Pat. No. 4,263,245.

In some embodiments, the polybenzimidazole (PBI) fiber comprises polybibenzimidazole polymer. One useful polybibenzimidazole polymer is poly(2,2′-(m-phenylene)-5,5′-bibenzimidazole) polymer. One commercial PBI polymer is prepared from tetra-aminobiphenyl and diphenyl isophthalate.

While the aromatic groups shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which doesn't interfere with preparation of the polymer, or no group at all. For example, that group may be aliphatic up to twelve carbon atoms, tolylene, biphenylene, bis-phenylene ether, and the like.

The polybenzoxazole and polybenzothiazole used to make fibers of this invention should have at least 25 and preferably at least 100 repetitive units. Preparation of the polymers and spinning of those polymers is disclosed in the aforementioned PCT application WO 93/20400.

Polypyridobisimidazole fibers are particularly suited for use in the instant invention. These fibers are made from rigid rod polymers that are of high strength. The polypyridobisimidazole fiber has an inherent viscosity of at least 20 dl/g or at least 25 dl/g or at least 28 dl/g. Such fibers include PIPD fiber (also known as M5® fiber and fiber made from poly[2,6-d]imidazo[4,5-b:4,5-e]-pyridinylene-1,4(2,5-dihydroxy)phenylene). PIPD fiber is based on the structure:

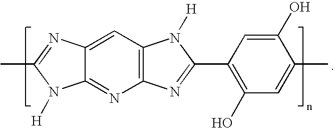

Polypyridobisimidazole fiber can be distinguished from the well known commercially available PBI fiber or polybenzimidazole fiber in that that polybenzimidazole fiber is a polybibenzimidazole. Polybibenzimidazole fiber is not a rigid rod polymer and has low fiber strength and low tensile modulus when compared to polypyridobisimidazoles.

PIPD fibers have been reported to have the potential to have an average modulus of about 310 GPa (2100 grams/denier) and an average tenacities of up to about 5.8 Gpa (39.6 grams/denier). These fibers have been described by Brew, et al., Composites Science and Technology 1999, 59, 1109; Van der Jagt and Beukers, Polymer 1999, 40, 1035; Sikkema, Polymer 1998, 39, 5981; Klop and Lammers, Polymer, 1998, 39, 5987; Hageman, et al., Polymer 1999, 40, 1313.

One method of making rigid rod polypyridoimidazole polymer is disclosed in detail in U.S. Pat. No. 5,674,969 to Sikkema et al. Polypyridoimidazole polymer may be made by reacting a mix of dry ingredients with a polyphosphoric acid (PPA) solution. The dry ingredients may comprise pyridobisimidazole-forming monomers and metal powders. The polypyridobisimidazole polymer used to make the rigid rod fibers used in the fabrics of this invention should have at least 25 and preferably at least 100 repetitive units.

For the purposes of this invention, the relative molecular weights of the polypyridoimidazole polymers are suitably characterized by diluting the polymer products with a suitable solvent, such as methane sulfonic acid, to a polymer concentration of 0.05 g/dl, and measuring one or more dilute solution viscosity values at 30° C. Molecular weight development of polypyridoimidazole polymers of the present invention is suitably monitored by, and correlated to, one or more dilute solution viscosity measurements. Accordingly, dilute solution measurements of the relative viscosity (“Vᵣₑₗ” or “ηᵣₑₗ” or “nᵣₑₗ”) and inherent viscosity (“Vᵢₙₕ” or “ηᵢₙₕ” or “nᵢₙₕ”) are typically used for monitoring polymer molecular weight. The relative and inherent viscosities of dilute polymer solutions are related according to the expression

Vᵢₙₕ=ln(Vᵣₑₗ)/C,

where ln is the natural logarithm function and C is the concentration of the polymer solution. Vᵣₑₗ is a unitless ratio of the polymer solution viscosity to that of the solvent free of polymer, thus Vᵢₙₕ is expressed in units of inverse concentration, typically as deciliters per gram (“dl/g”). Accordingly, in certain aspects of the present invention the polypyridoimidazole polymers are produced that are characterized as providing a polymer solution having an inherent viscosity of at least about 20 dl/g at 30° C. at a polymer concentration of 0.05 g/dl in methane sulfonic acid. Because the higher molecular weight polymers that result from the invention disclosed herein give rise to viscous polymer solutions, a concentration of about 0.05 g/dl polymer in methane sulfonic acid is useful for measuring inherent viscosities in a reasonable amount of time.

It is well known in the art that ultra-fine fibers can be prepared by flash spinning, electrostatic spinning, and melt-blown spinning. Nonwoven webs can be produced by a process that utilizes an electro-blown spinning process. In such a process, a polymer solution is discharged through a spinning nozzle to which a high voltage has been applied. The fiber spun from the nozzle is collected on a grounded suction collector. Typically, compressed air is injected at the lower end of the spinning nozzle. Such a processes for making nanofibers and webs containing such fibers can be found in PCT Patent Application WO03/080905, the disclosure of which is incorporated herein in its entirety.

As used herein the term “fiber” is defined as a relatively flexible, macroscopically homogeneous body having a high ratio of length to width across its cross-sectional area perpendicular to its length. The fiber cross section can be any shape, but is typically round. Herein, the term “filament” or “continuous filament” is used interchangeably with the term “fiber.”

As used herein, “basis weight” can be determined by ASTM D-3776, which is hereby incorporated by reference and reported in g/m².

As used herein, “fiber diameter” can be determined as follows. Ten scanning electron microscope (SEM) images at 5,000× magnification were taken of each nanofiber layer sample. The diameter of eleven (11) clearly distinguishable nanofibers were measured from each SEM image and recorded. Defects were not included (i.e., lumps of nanofibers, polymer drops, intersections of nanofibers). The average fiber diameter for each sample was calculated.

The present invention may be understood more readily by reference to the following detailed description of illustrative and preferred embodiments that form a part of this disclosure. It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

### EXAMPLES

The invention is illustrated by, but is not intended to be limited by the following examples.

### Example 1

### Polymer Process

11,580 grams of polyphosphoric acid (PPA) (84.7% P₂O₅) at 120° C. is fed from a weigh tank into a 10CV DIT Helicone mixer that has a nitrogen atmosphere of 1 atmosphere. (The mixer blades are stopped so as not to obscure the addition port.) After the PPA is in the mixer, the mixer blades are run at 40 rpm and the jacket cooling water is started to cool the PPA to 70° C. When the PPA is cooled, the water flow is stopped and the mixer blades are stopped so as not to obscure the addition port.

3400 grams of P₂O₅ are weighed into a transfer bin in a weigh chamber under dry nitrogen (N₂). The 1 atmosphere (absolute) nitrogen pressure in the mixer is equalized to the 1 atmosphere pressure in the N₂-blanketed weigh chamber. The P₂O₅ is transferred to the 10CV mixer, and then the transfer valve is closed. The mixer blades are started and their speed is ramped to 40 rpm. Water cooling is restarted and a vacuum is slowly applied to degas the mixture as the P₂O₅ is blended into the PPA. Water cooling is controlled to maintain the contents of the mixer at 75 (+/−5)° C. The pressure in the mixer is reduced to 50 mm Hg and mixing is continued for an additional 10 minutes. The water flow is then stopped and the mixer blades are stopped so as not to obscure the addition port. N₂ is admitted to bring the pressure up to 1 atmosphere (absolute).

10174 grams of monomer-complex are weighed into a transfer bin in a dry N₂ weigh chamber. In addition, 51 grams of tin powder (approx. 325 mesh) and 25 grams of benzoic acid are weighed into a separate N₂-blanketed transfer vessel in the same weigh chamber.

The 1 atmosphere (absolute) pressure in the mixer is equalized to the 1 atmosphere pressure in the N₂-blanketed weigh chamber. The monomer complex, tin, and benzoic acid are transferred to the 10CV mixer, and then the transfer valve is closed. The mixer blades are started and their speed is ramped to 40 rpm. Water cooling is restarted when the agitator starts, and the monomer complex, tin, and benzoic acid are blended into the PPA mixture for 10 minutes after the mixer blades have reached the 40 rpm rate. Then a vacuum is slowly applied to degas the mixture as the blending continues. Water cooling is controlled to maintain the contents of the mixer at 75 (+/−5)° C. The pressure in the mixer is reduced to 50 mm Hg pressure and mixing is continued for 10 minutes. Then the mixer blade speed is reduced to 12 rpm and water cooling is reduced to allow the temperature of the contents in the mixer to rise to 85 (+/−5)° C. The mixer blades are then stopped, N₂ is admitted to bring the pressure up to 1 atmosphere, and the contents of the mixer are then transferred to a feed tank having two agitators (a DIT 10SC mixer).

The reactant mixture in the feed tank is maintained at a temperature of 110° C. and a pressure of 50 mm Hg absolute. Both agitators are run at 40 rpm. The reactant mixture is pumped from the tank at an average rate of 10,050 grams/hour through a heat exchanger, to increase the temperature of the mixture to 137° C., and into a series of three static mixer reactors, allowing a 3-hour hold-up time for oligomer formation. Exiting the static mixer reactors, superphosphoric acid (SPA) (76% P₂O₅) is injected into the oligomer mixture at an average rate of 1079 grams/hour.

The oligomer mixture with SPA is then well blended through a static mixer and transferred to a stirred surge tank any volatiles are removed by a vacuum. The stirred surge tank is a DIT 5SC mixer, having a temperature maintained at 137° C. Average hold-up time in the surge tank is 1¼ hr.

### Polymerization of the Mixture

The oligomer mixture is then further polymerized to the desired molecular weight at a temperature of 180° C. The oligomer mixture is first pumped through a heat exchanger to raise the temperature of the mixture to 180 C and then through a reactor system of static mixers and a rotating Couette-type-shearing reactor imparting 5 sec⁻¹ shear rate to the polymerizing solution. The reactor system is maintained at 180° C. (+/−5 degrees) and the hold-up time in the reactor system is 4 hours. A solution containing a polymer having an inherent viscosity of 25 dl/g is obtained.

### Spinning Process

### Fiber Formation & Quenching

Electro-Blowing:

A 20 weight percent solution of 251V polymer in PPA (having a strength of equivalent of 81.5 percent P₂O₅ is forwarded to a spinnerette pack having electrically charged spinning nozzles. The spinning nozzles have a diameter of about 0.25 mm, an L/d ratio of about 10, DCD of 300 mm, a spinning pressure of about 6 kg/cm², and an applied voltage of about 50 kV. The number of spinning nozzles in the spinnerette pack is 51.

Surrounding the spinning nozzles are air nozzles that provide high pressure air for the electro-blowing process. The air velocity is about 3000 meters/minute and the air temperature is about 100° C.

The spun filaments are collected on a moving belt by suction to form a web. The distance between the spinnerette nozzle and suction collection belt is 30 cm.

### Hydrolysis Washing, & Drying

The web is sprayed with water at 40 degrees Celsius for 20 seconds. The web is then passed through an oven operating at a temperature of 300° C. for a residence time of 60 seconds. The web is then washed with a water spray. The water temperature is 40° C. The web is then dried by passing the web through an oven operating at 150° C. for a residence time of 40 seconds.

### Example 2

The process of example 1 is repeated except that the air velocity is 0 meters/minute.

### Example 3

The process of example 1 is repeated except that no voltage is applied to the spin nozzle.

### Example 4

This example illustrates the optional heat treatment of the web made in the previous examples. The process of a preceding example is repeated, except after drying, a volatile antistatic finish is applied to the web instead of a textile finish, and the web is immediately conveyed to an oven instead of being wound on a bobbin.

### Heat Treatment

The dried web is conveyed to an electrically heated belt, which raise the temperature of the web to 400° C. The web is then conveyed into a N₂-blanketed tube oven which raises the temperature of the yarn to 500° C. Before exiting the N₂ atmosphere, the web is cooled in a room temperature N₂ atmosphere for 2 seconds, and a finish is applied. The web is then collected.

What is claimed:

1. A fiber web comprising:
polymer fiber having an average fiber diameter of about 20 to 5000 nm;
the polymer fiber comprising a polyarenazole polymer having an inherent viscosity of greater than about 20 g/dl;
the fiber web having a basis weight of from about 0.1 to 200 grams per square meter.

2. The fiber web of claim 1 wherein the basis weight is in the range of about 0.1 to 100 grams per square meter.

3. The fiber web of claim 2 wherein the basis weight is in the range of about 0.3 to 80 grams per square meter.

4. The fiber web of claim 1 wherein the polyarenazole polymer has an inherent viscosity of greater than about 25 g/dl.

5. The fiber web of claim 1 wherein the polyarenazole polymer has an inherent viscosity of greater than about 28 g/dl.

6. The fiber web of claim 1 wherein the polyarenazole polymer fiber is a polypyridazole polymer fiber.

7. The fiber web of claim 6 wherein the polypyridazole polymer fiber is a poly[2,6-diimidazo[4,5-b:4,5-e]-pyridinylene-1,4-(2,5-dihydroxy)phenylene). polymer fiber.

8. The fiber web of claim 6 wherein the basis weight is in the range of about 0.1 to 100 grams per square meter.

9. The fiber web of claim 1 wherein the fiber web additionally includes a scrim.

10. An article comprising the fiber web of claim 1.

11. A method of producing a web of polyarenazole fibers comprising:
extruding a solution comprising polyarenazole polymer through a spinneret having a first applied voltage; and
collecting the extruded polyarenazole polymer on a collection surface optionally having a second applied voltage that is opposite in polarity to the first applied voltage.

12. The method of claim 11 wherein the solution comprising polyarenazole polymer comprises polyphosphoric acid as a solvent.

13. The method of claim 11 wherein the first applied voltage is in the range of ±1 kV to ±300 kV.

14. The method of claim 11 wherein the second applied voltage is in the range of 0 to ±10 kV.

15. The method of claim 11 wherein the polyarenazole polymer has an inherent viscosity of greater than about 28 g/dl.

16. The method of claim 11 wherein the polyarenazole polymer is a polypyridazole.

17. The method of claim 16 wherein the polypyridazole polymer is poly[2,6-d]imidazo[4,5-b:4,5-e]-pyridinylene-1,4-(2,5-dihydroxy)phenylene).

18. The method of claim 11 wherein the method additionally comprises the step of passing the extruded polyarenazole polymer solution through an air gap.

19. The method of claim 18 wherein the method additionally comprises the step of accelerating the extruded polymer solution in the air gap by providing air flow along the direction between the spinneret and collection surface

20. The method of claim 19 wherein the second applied voltage is zero.
